(19) United States
(12) Patent Application Publication
(10) Pub. No.: US 2026/0296790 A1
(43) Pub. Date: Oct. 1, 2026

(54) SYSTEM AND METHOD FOR CONTROLLING THE MOVEMENT OF CONTAINERS IN AN AUTOMATED STORAGE AND RETRIEVAL SYSTEM

(71) Applicant: AutoStore Technology AS, Nedre Vats (NO)

(72) Inventor: Rune Brattbakk Bilit, Asker (NO)

(21) Appl. No.: 18/998,200

(22) PCT Filed: Aug. 29, 2023
(86) PCT No.: PCT/EP2023/073626

§ 371 Date: Jan. 24, 2025

(30) Foreign Application Priority Data
Sep. 1, 2022 (NO) 20220942

(51) Int. Cl. B65G 1/137; B65G 1/04; F25D 13/00

(52) U.S. Cl. CPC B65G 1/1378; B65G 1/0464; B65G 1/0478; F25D 13/00

(57) ABSTRACT

A method for returning containers to the grid after finished picking in the port in a system comprising a framework structure (100) forming a three-dimensional storage grid structure (104) for storing storage containers (106) for storing items, where the grid structure (104) forms vertical storage columns (105) each having a horizontal area defined by the size of an access opening (112) of the vertical storage columns (105) and where the framework structure comprises a rail system (108) arranged above the storage columns (105), the rail system comprising a plurality of rails extending in an X-direction and a Y-direction to form a grid, the rails defining a perimeter of each access opening (112) on top of each storage column (105), the rail system (108) providing available routes in the X-direction or the Y-direction for container handling vehicles (201, 301) handling and transferring the storage containers (106) to and from the storage columns (105), and a central computer system with a Warehouse Management System (WMS) for controlling the operation of the storage and retrieval system wherein the method comprises the following steps; using a container handling vehicle to transport a container from the storage and retrieval system to a port for picking of at least one item stored in the container, picking the indicated items from the container in the port, registering the container as finished in the port, sending the container back automatically into the storage and retrieval system if the container has not been sent out of the port by a second container waiting to be picked, or that the container is not requested at another port.

### FIELD OF THE INVENTION

The present invention relates to an automated storage and retrieval system for storage and retrieval of containers, in particular to a system and method for automatic sending of containers back to the grid after the desired items have been retrieved at the port.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as containers, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c, 401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107.

However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

If the storage and retrieval system has e.g. a section that has items that needs to be stored in a temperature sensitive sone, it is a necessity that a container with items that needs to be stored in a temperature sensitive zone is brought back into the temperature controlled part of the storage and retrieval system after the items have been picked at the port.

This is usually not a problem as containers are automatically sent back into the storage and retrieval system after picking by their place at the port being replaced with a new container that needs to be picked.

However, occurrences can happen that there are no other containers waiting to enter the port, or the container in question is not needed to be sent to another port., then the container in question can be left in the port for a long time. this is not ideal for items that might need to be kept frozen or chilled.

### SUMMARY OF THE INVENTION

The present invention is set forth and characterized in the independent claims, while the dependent claims describe other characteristics of the invention.

A first aspect of the present invention regards a method for controlling the movement of containers in an automated storage and retrieval system comprising a framework structure (100) forming a three-dimensional storage grid structure (104) for storing storage containers (106) for storing items, where the framework structure (100) forms vertical storage columns (105) each having a horizontal area defined by the size of an access opening (112) of the vertical storage columns (105) and where the framework structure comprises a rail system (108) arranged above the storage columns (105), the rail system comprising a plurality of rails extending in an X-direction and a plurality of rails extending in a Y-direction to form a grid, the rails defining a perimeter of each access opening (112) on top of each storage column (105), the rail system (108) providing available routes in the X-direction or the Y-direction for container handling vehicles (201, 301) handling and transferring the storage containers (106) to and from the storage columns (105), and a central computer system, the grid structure (104) further comprising a port column (119, 120) which comprises a port where container handling vehicles (201, 301) can drop off and/or pick up storage containers (106) so that they can be transported to an access station for picking wherein the method comprises using a container handling vehicle to pick up a storage container from a temperature controlled and/or atmospherically controlled zone in the automated storage and retrieval system, transporting the storage container from the atmospherically controlled zone for picking, setting a timer running to monitor an elapsed time, comparing the elapsed time to a predetermined threshold, when the elapsed time exceeds the predetermined threshold, retrieving the storage container and transport it back into the atmospherically controlled zone.

Further, the storage container can be retrieved from the port when the elapsed time exceeds the predetermined threshold if the storage container has not been sent out of the port by a second storage container waiting to be picked, or has not been requested at another port before the elapsed time exceeds the predetermined threshold.

Also, the timer can be set running when the storage container arrives at the port, such that the elapsed time corresponds to the time that the storage container has spent in the port. The timer can be set running when the system has finished picking from the storage container at the port, such the elapsed time corresponds to the time that the storage container has spent in the port after picking from the storage container has been completed. Alternatively, the timer can be set running when the storage container leaves the temperature controlled and/or atmospherically-controlled zone, such that the elapsed time corresponds to the time that the storage container has been outside of the temperature controlled and/or atmospherically-controlled zone.

Also, the method can comprise retrieving the storage container from the port after the elapsed time exceeds the predetermined threshold, even if the storage container is not finished being picked in the port.

Further, a second storage container can be removed from the port to allow the storage container access to the port, also rearranging a queue of containers to be picked at the port in order to allow the storage container to be picked before other storage containers which need not be stored in the atmospherically controlled zone, and rearranging a queue of containers to be collected from the port in order to allow the storage container to be retrieved before other storage containers which need not be stored in the atmospherically controlled zone.

In a second aspect, the invention concerns an automated storage and retrieval system comprising a framework structure (100) forming a three-dimensional storage grid structure (104) for storing storage containers (106) for storing items, where the grid structure (104) forms vertical storage columns (105) each having a horizontal area defined by the size of an access opening (112) of the vertical storage columns (105) and where the framework structure comprises a rail system (108) arranged above the storage columns (105), the rail system comprising a plurality of rails extending in an X-direction and a Y-direction to form a grid, the rails defining a perimeter of each access opening (112) on top of each storage column (105), the rail system (108) providing available routes in the X-direction or the Y-direction for container handling vehicles (201, 301) handling and transferring the storage containers (106) to and from the storage columns (105), the grid structure comprises an atmospherically-controlled zone in which the temperature and/or atmospheric content is controlled, the grid structure (104) further comprising a port column (119, 120) which comprises a port where container handling vehicles (201, 301) can drop off and/or pick up storage containers (106) so that they can be transported to an access station for picking and a central computer system for controlling the operation of the automated storage and retrieval system, wherein the central computer is configured to send a container handling vehicle to retrieve a storage container from the atmospherically controlled zone in the automated storage and retrieval system to transport the storage container to the port for picking, set a timer running to monitor an elapsed time, compare the elapsed time to a predetermined threshold, when the elapsed time exceeds the predetermined threshold, send a container handling vehicle to retrieve the storage container from the port and transport it back into the temperature controlled and/or atmospherically controlled zone.

A storage container which contains items that need to be stored in a temperature controlled and/or atmospherically-controlled zone.

The central computer is configured to rearrange a queue of storage containers going to or leaving the port, to minimize the amount of time which storage containers which contain items that need to be stored in a particular atmospheric condition spend outside of the atmospherically controlled zone, and the central computer system prioritizes the tasks containing items that need to be stored in a controlled atmospheric condition higher than tasks containing items that can be stored in ordinary climate also the central computer system can issue an auto-flushing and if the central computer system does not request a new container to be picked in the port.

A third aspect the invention is directed to a computer program product, the computer program product including instructions that, when executed by a computer, cause the computer to perform the method according to the invention stated in the method claims in the set of claims.

By using the solution presented here the problem with containers with e.g. temperature sensitive items stored in it is solved by the fact that the container will be automatically returned to the grid after the picking has is finished and a predetermined period of time has passed.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a flow chart describing an embodiment of the present invention.

FIG. 6 is a flow chart describing an alternative embodiment of the present invention.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

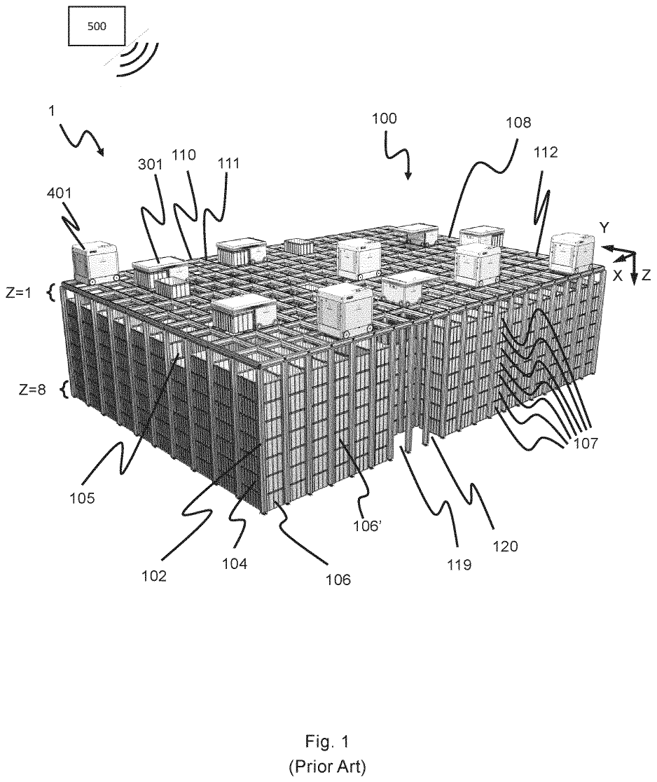

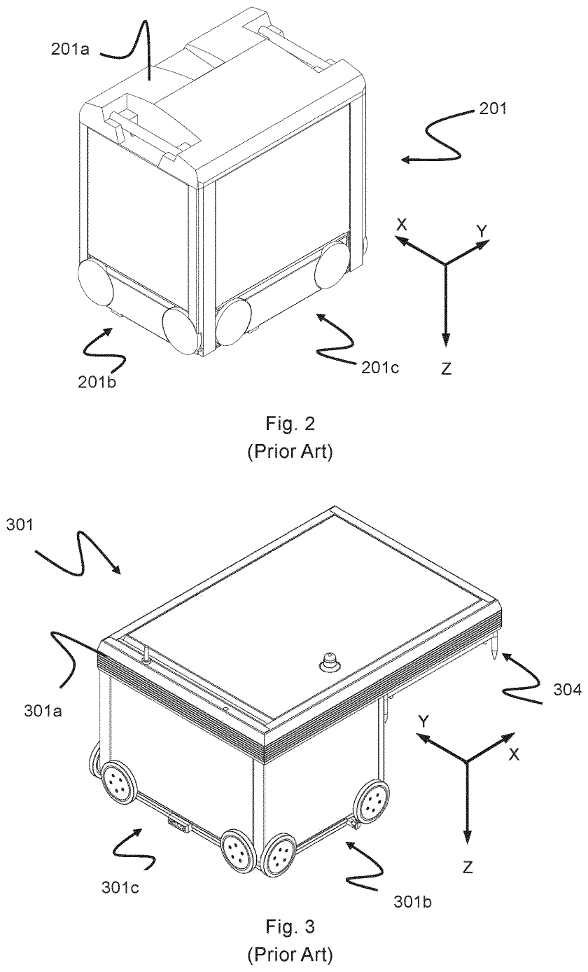

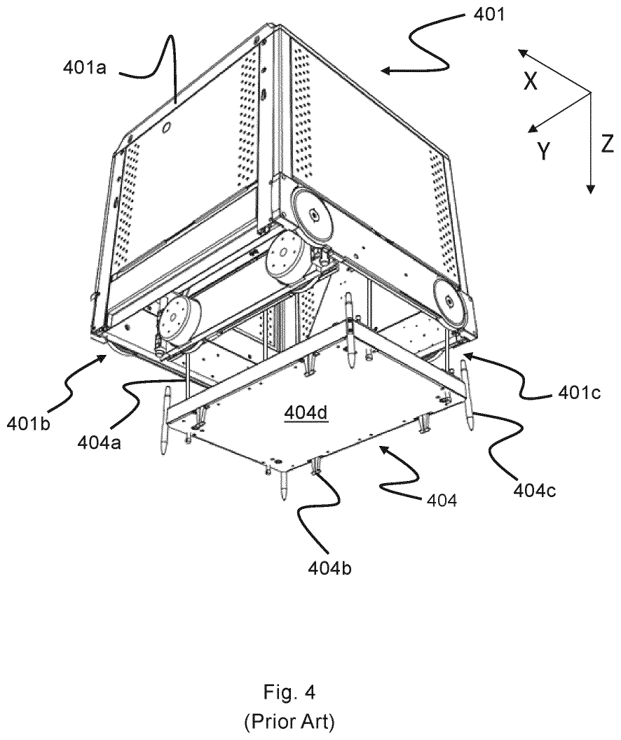

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

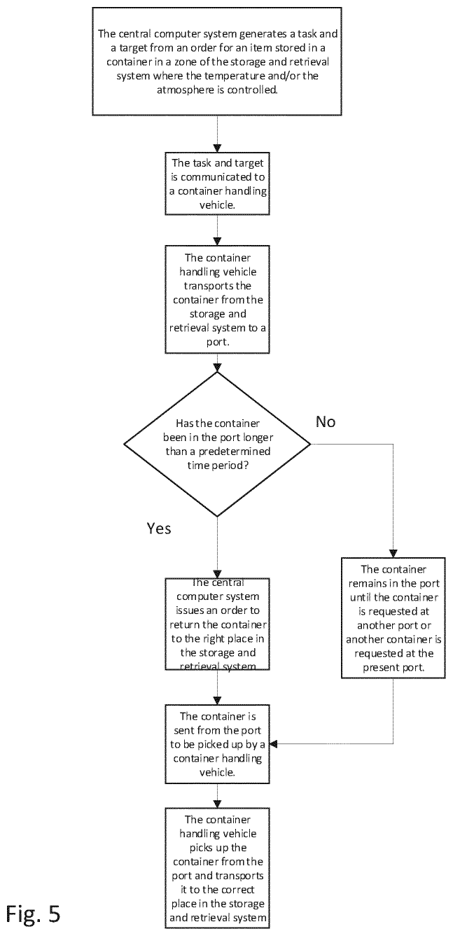

One embodiment of the automated storage and retrieval system according to the invention will now be discussed in more detail with reference to FIG. 5.

FIG. 5 is a flow chart describing an embodiment of the present invention.

Some storage and retrieval systems have zones for items that needs to be stored in a temperature controlled zone or a zone with particular atmospheric conditions.

Hence it is a necessity that a container with the such items is brought back into the temperature controlled and/or the atmospherically controlled part of the storage and retrieval system after the items have been picked at the port.

This is usually not a problem as containers are automatically sent back into the storage and retrieval system after picking by their place at the port being replaced with a new container that needs to be picked.

However, sometimes there are no other containers waiting to enter the port, or the container in question is not needed to be sent to another port, and the container in question can then be left in the port for a long time. This is not ideal for items that should not be kept outside the zone with the right temperature and/or atmospheric condition.

The present invention therefore presents the possibility that central computer system can issue an order to retrieve the container from the port and transport it back into the storage and retrieval system and in particular, to transport it back to the temperature-controlled and/or atmosphere-controlled zone if the container is finished at the port and if the central computer system does not request a new container to be picked in the port within a predetermined period of time.

An embodiment of the present invention comprises the following steps:
The central computer system generates a task and a target from an order for an item stored in a part of the storage and retrieval system that is a temperature controlled and/or atmospheric controlled zone.
The task and target are communicated to a container handling vehicle.
The container handling vehicle transports the container from the storage and retrieval system to a port.
Has the container been in the port longer than a predetermined time period?
   If no: the container remains in the port until the container is requested at another port or another container is requested at the present port,
   If yes: the central computer system issues an order to return the container to the right place in the storage and retrieval system.
The container is sent from the port to be picked up by a container handling vehicle.
The container handling vehicle picks up the container from the port and transports it to the correct place in the storage and retrieval system.

In order to keep track of the time the container has been out of the temperature controlled and/or the atmospherically controlled zone of the storage and retrieval system, the central computer system sets a timer running to monitor an elapsed time, further the elapsed time is compared to a predetermined threshold, and when the elapsed time exceeds the predetermined threshold, the central computer system sends a an order to retrieve the storage container and transport it back into the temperature controlled and/or atmospherically controlled zone.

The timer can be set running when the storage container arrives at the port, such that the elapsed time corresponds to the time that the storage container has spent in the port. Alternatively, the timer can be set running when the storage container leaves the temperature controlled and/or atmospherically-controlled zone, such that the elapsed time corresponds to the time that the storage container has been outside of the temperature controlled and/or atmospherically-controlled zone.

If the threshold is overstepped the central computer system generates an order to retrieve the storage container from the port even if the storage container is not finished being picked in the port.

If the central computer system knows that there are other containers waiting in line to be dropped off by container handling vehicles at the port it can order the removing of the other containers from the port to allow the storage container with the items that is sensitive to temperature and atmospheric conditions access to the port. The central computer system can also rearrange a queue of containers to be picked at the port in order to allow the storage container to be picked before other storage containers which need not be stored in the atmospherically controlled zone

Examples of the types of items that needs to be stored in temperature controlled zones are frozen foods that need to be stored in frozen conditions in order to be within the parameters set by the health authorities. There can be many different frozen zones for storing items that needs to be kept at different temperatures.

Further there are many items that needs to be stored in chilled conditions like milk products, raw meat products, mayonnaise based products and similar.

Examples of the types of items that needs to be stored in atmospherically controlled zones can be plants, certain plants require both a temperature controlled zone and a specific atmospheric condition where the levels of e.g. oxygen, nitrogen, carbon dioxide, water vapor, and argon are different than those of ambient air.

Another atmospheric condition can be items that needs to be stored in a fire suppressant atmosphere for storing flammable objects or dust free for clean-room objects.

The examples made here of items that is sensitive to temperature and/or atmospheric conditions are just made to give an idea of the types of items that can be stored in such places it is not meant as an exhaustive list.

The zones are parts of the storage and retrieval system that is particularly controlled it is not the entire system.

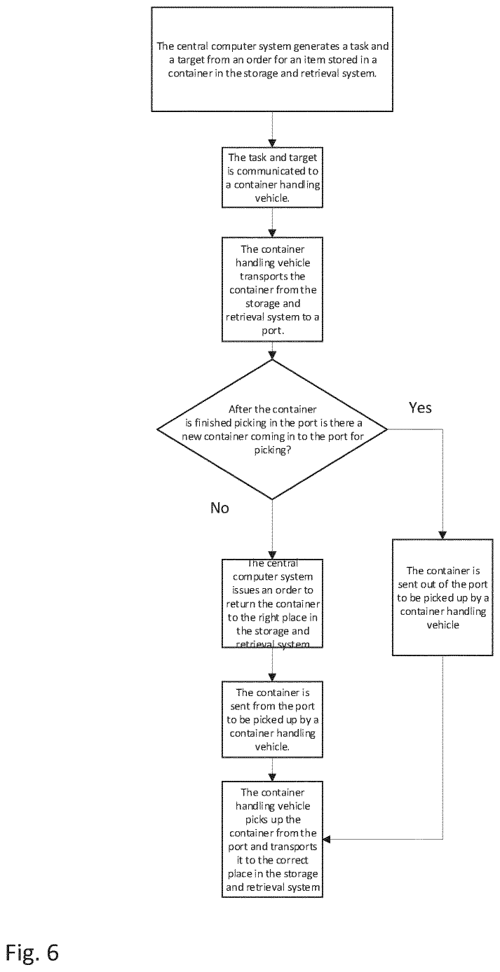

FIG. 6 is a flow chart describing an alternative embodiment of the present invention. In an alternative embodiment of the present invention the central computer system sends an order to empty all the containers from ports that are inactive. This means that if a port does not have a new container that needs to be picked coming in, the central computer system creates at least one job ordering the containers in the inactive ports to be picked up by container handling vehicles and transported back into the storage and retrieval system.

If the central computer system registers that one or more ports do not have another container coming in for picking the central computer system sends messages to at least one container handling vehicle to retrieve the containers that are in the port(s) and transport them back into the grid of the storage and retrieval system.

This system is called an auto flushing of container from a port.

Auto-flushing of containers in a port provides the possibility to enable a way to automatically empty a port after a configured timeout. The concept is that an automatic flush will trigger if the central computer system has not requested a container in the corresponding port in a preconfigured time. As an example, if the configuration specifies 60 seconds, the central computer system will automatically flush all containers in the port 60 seconds after the previous container was closed if the central computer system does not request a new container to be opened in the port. This applies regardless of the mode of the port (i.e. regardless of whether the port is still open or not).

The central computer system can specify a desired timeout value, that is used to automatically retrieve the containers from port. This will ensure that the containers are put back into the area of the grid where they belong-thus ensuring the desired environment for the containers.

A timeout is the time elapsed since the last container was finished at the port. E.g. since the operator registers the container as finished picking.

In the preceding description, various aspects of the delivery vehicle and the automated storage and retrieval system according to the invention have been described with reference to the illustrative embodiment. For purposes of explanation, specific numbers, systems, and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

### Prior Art (FIGS. 1-4)

1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction

1.-14. (canceled)

15. A method for controlling movement of containers in an automated storage and retrieval system comprising a framework structure forming a three-dimensional storage grid structure for storing storage containers for storing items, where the framework structure forms vertical storage columns each having a horizontal area defined by a size of an access opening of the vertical storage columns and where the framework structure comprises a rail system arranged above the vertical storage columns, the rail system comprising a plurality of rails extending in an X-direction and a plurality of rails extending in a Y-direction to form a grid, the plurality of rails defining a perimeter of each access opening on top of each storage column, the rail system providing available routes in the X-direction or the Y-direction for container handling vehicles handling and transferring the storage containers to and from the vertical storage columns, and a central computer system, the storage grid structure further comprising a port column which comprises a port where the container handling vehicles can drop off and/or pick up the storage containers so that the storage containers can be transported to an access station for picking, wherein the method comprises:
using one of the container handling vehicles to pick up a first storage container from a temperature controlled or atmospherically controlled zone in the automated storage and retrieval system;
transporting the first storage container from the temperature controlled or atmospherically controlled zone for picking;
setting a timer running to monitor an elapsed time;
comparing the elapsed time to a predetermined threshold; and
when the elapsed time exceeds the predetermined threshold, retrieving the first storage container and transporting the first storage container back into the temperature controlled or atmospherically controlled zone.

16. The method of claim 15, wherein the first storage container is retrieved from the port when the elapsed time exceeds the predetermined threshold if the first storage container has not been sent out of the port by a second storage container waiting to be picked or has not been requested at another port before the elapsed time exceeds the predetermined threshold.

17. The method of claim 15, wherein the timer is set running when the first storage container arrives at the port, such that the elapsed time corresponds to a time that the first storage container has spent in the port.

18. The method of claim 15, wherein the timer is set running when the automated storage and retrieval system has finished picking from the storage containers at the port, such that the elapsed time corresponds to a time that the first storage container has spent in the port after picking from the storage containers has been completed.

19. The method of claim 15, wherein the timer is set running when the first storage container leaves the temperature controlled or atmospherically-controlled zone, such that the elapsed time corresponds to a time that the first storage container has been outside of the atmospherically-controlled zone.

20. The method of claim 15, further comprising removing a second storage container from the port to allow the first storage container access to the port.

21. The method of claim 15, further comprising rearranging a queue of storage containers to be picked at the port in order to allow the first storage container to be picked before other storage containers which need not be stored in the temperature controlled or atmospherically-controlled zone.

22. The method of claim 15, further comprising rearranging a queue of storage containers to be collected from the port in order to allow the first storage container to be retrieved before other storage containers which need not be stored in the temperature controlled or atmospherically-controlled zone.

23. An automated storage and retrieval system comprising a framework structure forming a three-dimensional storage grid structure for storing storage containers for storing items, where the storage grid structure forms vertical storage columns each having a horizontal area defined by a size of an access opening of the vertical storage columns and where the framework structure comprises a rail system arranged above the vertical storage columns, the rail system comprising a plurality of rails extending in an X-direction and a Y-direction to form a grid, the plurality of rails defining a perimeter of each access opening on top of each storage column, the rail system providing available routes in the X-direction or the Y-direction for container handling vehicles handling and transferring the storage containers to and from the vertical storage columns, the storage grid structure comprises an atmospherically-controlled zone in which a temperature and/or atmospheric content is controlled, the storage grid structure further comprising a port column which comprises a port where container handling vehicles can drop off and/or pick up the storage containers so that they can be transported to an access station for picking and a central computer system for controlling an operation of the automated storage and retrieval system, wherein the central computer is configured to:
send a first container handling vehicle of the container handling vehicles to retrieve a first storage container from the atmospherically controlled zone in the automated storage and retrieval system to transport the first storage container to the port for picking;
set a timer running to monitor an elapsed time;
compare the elapsed time to a predetermined threshold; and
when the elapsed time exceeds the predetermined threshold, send a second container handling vehicle of the container handling vehicles to retrieve the first storage container from the port and transport the first storage container back into the atmospherically controlled zone.

24. The automated storage and retrieval system of claim 23, wherein the first storage container contains items that need to be stored in the atmospherically-controlled zone.

25. The automated storage and retrieval system of claim 23, wherein the central computer is configured to rearrange a queue of storage containers going to or leaving the port, to minimize an amount of time in which storage containers which contain items that need to be stored in a particular atmospheric condition spend outside of the atmospherically controlled zone.

26. The automated storage and retrieval system of claim 23, wherein the central computer system is configured to prioritize tasks containing items that need to be stored in a controlled atmospheric condition higher than other tasks containing items that can be stored in ordinary climate.

27. The automated storage and retrieval system of claim 23, wherein the central computer system is configured to issue an auto-flushing if the central computer system does not request a new storage container to be picked in the port.

28. A computer program product including instructions that, when executed by a computer, cause the computer to perform the method according to claim 15.
